(19) United States
(12) Patent Application Publication
(10) Pub. No.: US 2008/0055327 A1
(43) Pub. Date: Mar. 6, 2008

(54) Highly Efficient Display FIFO

(76) Inventors: Barinder Singh Rai, Surrey (CA); Manfred Wittmeir, Maibergweg (DE)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/470,491

(22) Filed: Sep. 6, 2006

(51) Int. Cl. G09G 5/36

(52) U.S. Cl. 345/558

(57) ABSTRACT

A graphics controller including a display pipe and a first-in-first-out (FIFO) buffer within the display pipe is provided. The FIFO buffer stores pixel data representing an image for display. The pixel data includes a pixel value and a corresponding repeater value. The repeater value indicates the number of times the pixel value is successively repeated within the image. The selection logic counts a number of times a pixel value is output and is configured to pause fetching of a next pixel value from the FIFO buffer until the pixel value has been output as many times as indicated by the repeater value.

### BACKGROUND OF THE INVENTION

The increase of portable electronics utilizing liquid crystal displays (LCDs) has also increased the demand for graphics controllers capable of supporting LCDs. Concurrent with the increasing demand for LCDs and their respective graphics controllers is an increase in complexity of the images that are being processed by the graphics controllers.

In order to display images, graphics processors have buffers that temporarily store data before the data is sent to an LCD controller. Increasing the size of the memory buffers can help a graphics controller handle more complex images. However, the increased memory also increases both the manufacturing costs and the power consumption. Either side effect is highly undesirable in the competitive field of portable electronics where consumers desire affordable products capable of operating for extended periods before batteries need to be recharged. In view of the forgoing, there is a need for a graphics controller that has an efficient buffer capable of storing pixel data for complex images while minimizing the size of the buffer in order to keep power consumption and manufacturing costs at a minimum.

### SUMMARY

In one embodiment a graphics controller including a display pipe and a first-in-first-out (FIFO) buffer within the display pipe is provided. The FIFO buffer stores pixel data representing an image for display. The pixel data includes a pixel value and a corresponding repeater value. The repeater value indicates the number of times the pixel value is successively repeated within the image. The selection logic counts a number of times a pixel value is output and is configured to pause fetching of a next pixel value from the FIFO buffer until the pixel value has been output as many times as indicated by the repeater value.

In another embodiment, a method for writing to a FIFO buffer is provided. The method includes recording to a register a preceding pixel data wherein the pixel data includes a preceding pixel value and a corresponding preceding repeater value. The method continues by retrieving a next pixel value from a memory and comparing the next pixel value to the preceding pixel value using system logic. If the next pixel value is equal to the preceding pixel value, the method includes incrementing the preceding repeater value. If the new pixel value is different than the preceding pixel value, the method includes writing the next pixel value and a corresponding next repeater value to a register within the FIFO buffer and designating the next pixel as the preceding pixel.

In yet another embodiment, a method for reading from a FIFO buffer is provided. The method includes accessing a register storing pixel data in a FIFO buffer wherein the pixel data includes a pixel value and a repeater value. The method continues by reading the repeater value stored with the pixel value using system logic. The method further includes outputting the pixel value as many times as indicated by the repeater value while pausing the fetching of the next pixel data. The method concludes by designating the register storing the pixel data as open.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1 is a simplified schematic diagram illustrating a high level architecture of a device for displaying graphics in accordance with one embodiment of the present invention.

FIG. 2 is a simplified schematic diagram illustrating a high level architecture for the graphics controller in accordance with one embodiment of the present invention.

FIG. 3 is an illustration of a display pipe in accordance with one embodiment of the present invention.

FIG. 4 is an alternative illustration of a display pipe in accordance with one embodiment of the present invention.

FIG. 5 is a flowchart of a procedure to use a display pipe in accordance with one embodiment of the present invention.

FIG. 6 is a flowchart of a procedure to access pixel data from a display pipe in accordance with one embodiment of the present invention.

### DETAILED DESCRIPTION

An invention is disclosed for improving the efficiency of FIFO buffers. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

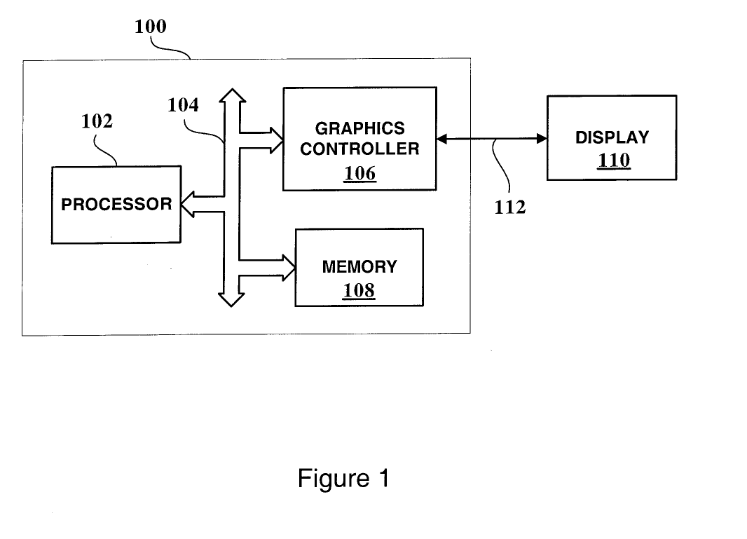

FIG. 1 is a simplified schematic diagram illustrating a high level architecture of a device 100 for displaying graphics in accordance with one embodiment of the present invention. The device 100 includes a processor 102, a graphics controller 106, a memory 108, all communicating with each other using a bus 104. The graphics controller 106 communicates with a display 110 through an interface.

The timing control signals and data lines between the graphics controller 106 and the display 110 are shown generally as a line 112. These may in fact be several separate address, data and control lines but are shown generally as the line 112, which may be referred to as a bus. It should be recognized that such data pathways may be represented throughout the figures as a single line. The processor 102 performs digital processing operations and communicates with the graphics controller 106 and the memory 108 over the bus 104. However, in other embodiments, the processor 102 communicates over several address, data, and control lines.

In addition to the components mentioned above and illustrated in FIG. 1, those skilled in the art will recognize that there may be many other components incorporated into the device 100, consistent with the application. For example, if the device 100 is a portable electronic device such as a cell phone, then a wireless network interface, random access memory (RAM), digital-to-analog and analog-to-digital converters, amplifiers, keypad input, and so forth will be provided. Likewise, if the device 100 is a personal data assistant (PDA), various hardware consistent with a PDA will be included in the device 100. The claimed invention can be implemented in any device using a display such as portable electronic devices. Examples of portable electronic devices include, portable gaming devices, digital audio players, portable video systems, and handheld computing devices. It will be understood that FIG. 1 is not intended to be limiting, but rather to present those components directly related to novel aspects of the device.

The processor 102 performs digital processing operations and communicates with the graphics controller 106. The processor 102 is an integrated circuit capable of executing instructions retrieved from the memory 108. These instructions provide the device 100 with functionality when executed on the processor 102. The processor 102 may also be a digital signal processor (DSP) or other processing device.

The memory 108 may be random-access memory or non-volatile memory. The memory 108 may be non-removable memory such as embedded flash memory or other EEPROM, or magnetic media. Alternatively, the memory 108 may take the form of a removable memory card such as ones widely available and sold under such trade names such as “miniSD”, “SD Card,” “Compact Flash,” and “Memory Stick.” The memory 108 may also be any other type of machine-readable removable or non-removable media. Additionally, the memory 108 may be remote from the device 100. For example, the memory 108 may be connected to the device 100 via a communications port (not shown), where a BLUETOOTH® interface or an IEEE 802.11 interface, commonly referred to as “Wi-Fi,” is included. Such an interface may connect the device 100 with a host (not shown) for transmitting data to and from the host. If the device 100 is a communications device such as a cell phone, the device 100 may include a wireless communications link to a carrier, which may then store data on machine-readable media as a service to customers, or transmit data to another cell phone or email address. Furthermore, the memory 108 may be a combination of memories. For example, it may include both a removable memory for storing media files such as music, video or image data, and a non-removable memory for storing data such as software executed by the processor 102.

The display 110 can be any form of display capable of displaying a digital image. In one embodiment, the display 110 is a liquid crystal display (LCD). In another embodiment the display 110 is a matrix of organic light-emitting diodes (OLED). Other types of displays are available or may become available that are capable of displaying an image that may be used in conjunction with the device 100.

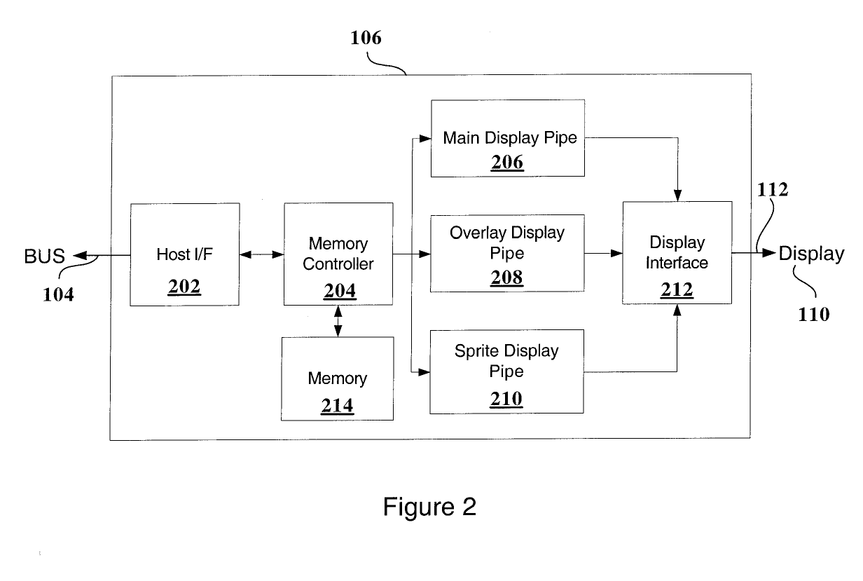

FIG. 2 is a simplified schematic diagram illustrating a high level architecture for the graphics controller 106 in accordance with one embodiment of the present invention. The graphics controller 106 includes a host interface (I/F) 202, a memory controller 204, a main display pipe 206, an overlay display pipe 208, a sprite display pipe 210, a memory 214 and a display interface 212. The graphics controller 106 communicates with the other components of the device 100 using the bus 104 as discussed above.

The host I/F 202 is used to communicate between the graphics controller 106 and the other components connected to the bus 104. One of the many function of the host I/F 202 is to ensure that input and output data at different clock frequencies are properly synchronized.

The memory controller 204 responds to requests from the display pipes and retrieves pixel values stored in the memory 214. The memory controller 204 has direct access to the memory 214 which, in this embodiment, is memory dedicated to the graphics processor. The memory 214 can be of various forms of machine-readable/writeable media such DRAM, SRAM, or magnetic media. Other types of memory are available or may become available that are capable of temporarily storing data and may be used in conjunction with the graphics controller 106. In another embodiment the memory accessed by the memory controller 204 may be shared with the device 100, such as the memory 108 shown in FIG. 1. In yet another embodiment the memory accessible by the memory controller 204 may be a combination of the memory 214 and the memory 108 shown in FIG. 1.

The main display pipe 206, the overlay display pipe 208 and the sprite display pipe 210 temporarily store pixel data for the images to be sent to the display interface 212. The display interface 212 receives pixel values from the various display pipes and outputs the resulting data to the display 110. The various display pipes work on a first-in-first-out (FIFO) basis and contain buffers so the display 110 can be refreshed with the appropriate images. The main display pipe 206 provides a buffer to store pixel data for the main display. The overlay display pipe 208 provides a buffer to store pixel data for a graphical overlay such as a wallpaper or background image. The sprite display pipe 210 provides a buffer to store pixel data for sprite images or animations. Those skilled in the art will recognize that additional or fewer display pipes can be used and the types of display pipes listed above are not meant to be inclusive. Rather, the examples used are simply representative of the type of graphics capable of benefiting from the use of display pipes. Display pipes given different names are still within the scope of this disclosure if the display pipes provide the same level of functionality.

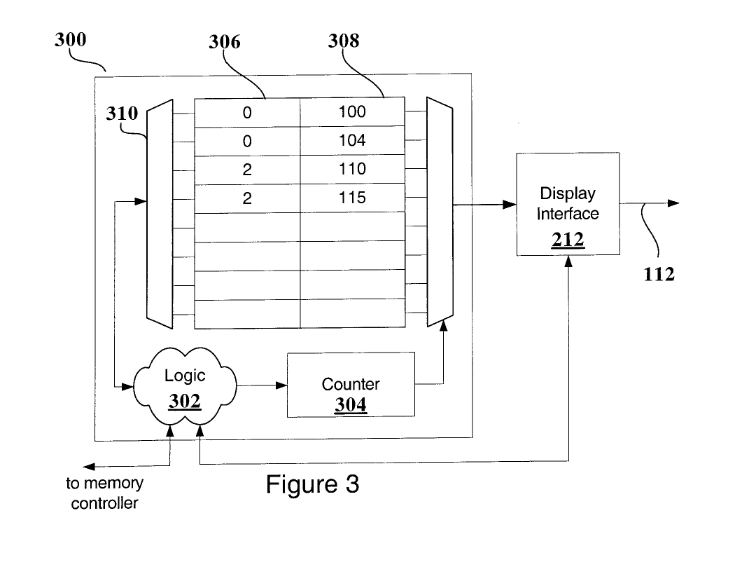

FIG. 3 is an illustration of a display pipe 300 in accordance with one embodiment of the present invention. The display pipe 300 contains logic 302, a counter 304, a pixel value registry 308 for storing pixel values, and a repeater registry 306 for storing a repeater value corresponding to the pixel value. Though shown as separate, the repeater registry 306 and the pixel value registry 308 can be one registry entry with the repeater value being stored as the least significant bit.

The logic 302 sends a request for a pixel value to the memory controller 204 of FIG. 2. The pixel value is fetched from the memory and the retrieved pixel value is compared to a preceding pixel value. If there is no preceding pixel value, the retrieved pixel value is stored in the pixel value registry 308 and a repeater value of zero is recorded in the corresponding repeater registry 306. If the retrieved pixel value is different than the preceding pixel value the pixel value is transmitted to a multiplexer 310 that directs the pixel value to the appropriate pixel value registry 308 and a repeater value of zero is recorded in the corresponding repeater registry 306. If the retrieved pixel value is the same as the previously stored pixel value, the logic 302 increments the repeater value in the repeater registry 306 for the previously stored pixel. With regard to FIG. 3, the pixel value registry 308 contains the pixel values for four pixels with corresponding repeater values stored in the repeater registry 306. The pixel value of 110 has a repeater value of 2 resulting in the pixel value 110 being output a total of three times before the next pixel value of 115 is output.

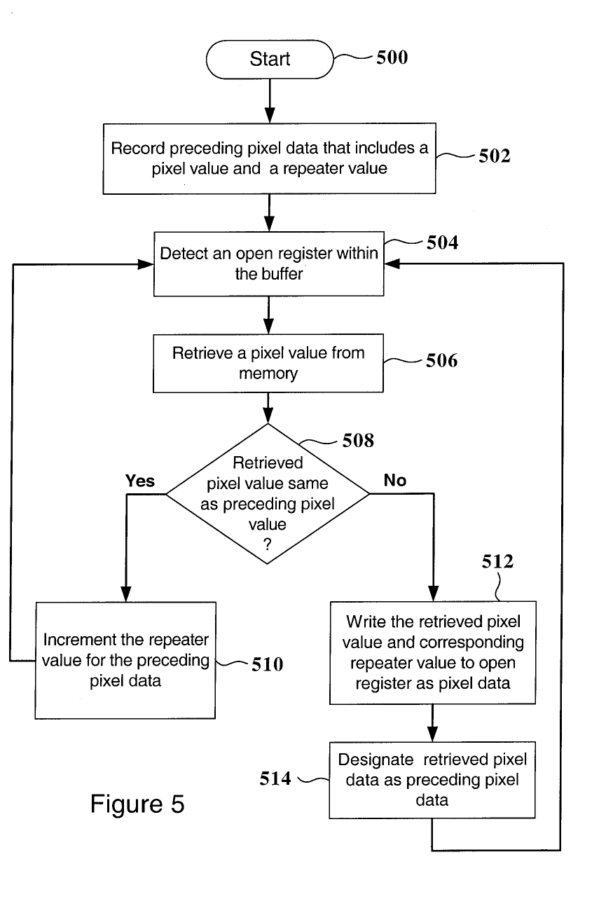

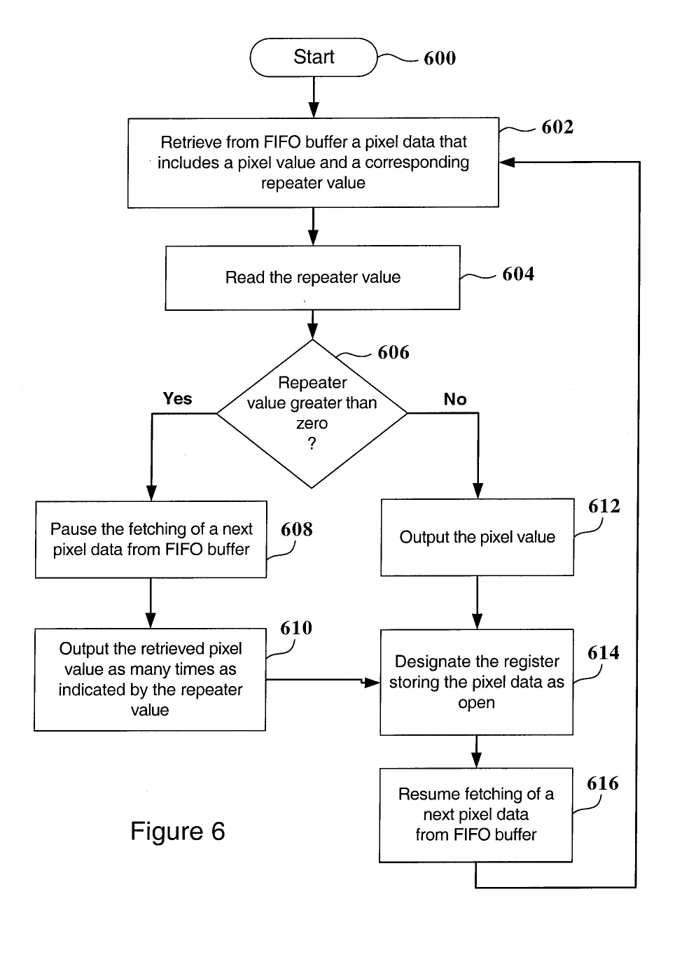

The display interface 212 communicates with the logic 302 and indicates when the display needs to be refreshed in order to extract the proper pixels from the pixel value registry 308. The logic 302 also communicates with the counter 304. The counter 304 is used to keep track of the number of times a pixel is output from the pixel value registry 308. After receiving a request to refresh the display from the display interface 212 the pixel value is retrieved and the corresponding repeater value is read. If the repeater value is greater than zero, the logic 302 pauses the fetching of the next pixel value from the memory 214 and outputs the pixel value the required number of times. The counter 304, in conjunction with the logic 302, decrements the corresponding repeater value as the pixel value is repetitively sent to the display interface 212. After decrementing the repeater value until the pixel value no longer needs to be sent, i.e. the repeater value is zero, the fetching of the next pixel value resumes. Further information of the operation of the display pipe will be disclosed in the discussion of FIG. 5 and FIG. 6.

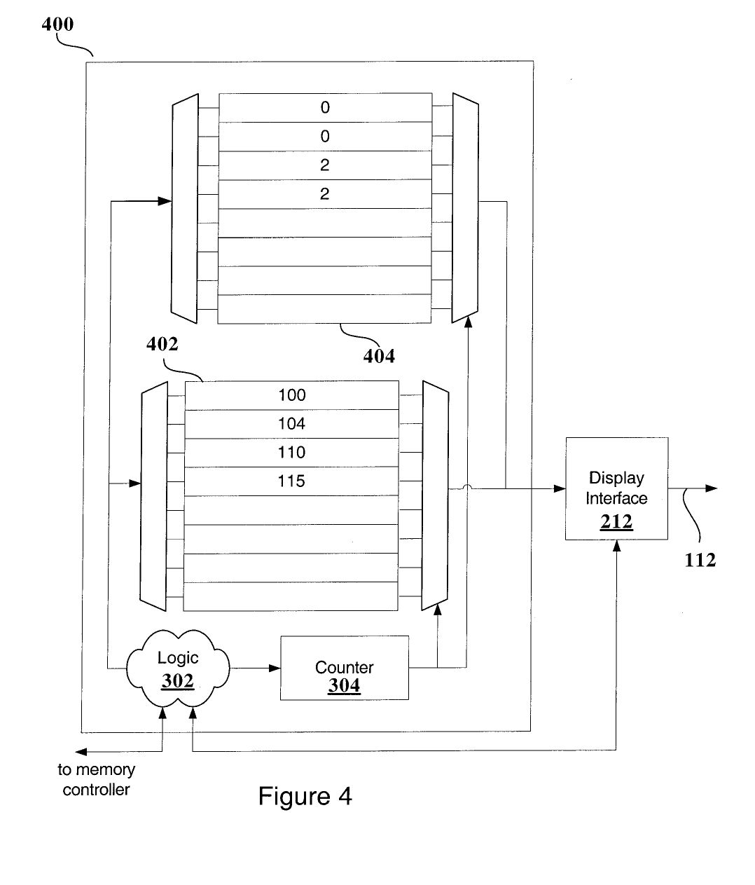

FIG. 4 is an illustration of a display pipe 400 in accordance with one embodiment of the present invention. In this embodiment the display pipe 400 utilizes a pixel value registry 402 and a repeater value registry 404 that are separated from each other. The logic 302 sends the pixel values to the pixel value registry 402 and any corresponding repeater value is sent to a corresponding location within the repeater value registry 404. The logic 302 and the counter 304 each communicate with the respective registries. The output from the registries is communicated to the display interface 212. Associating the overlay display pipe 208 with FIG. 4 was done for exemplary reasons and should not be considered restrictive. Similarly, the main display pipe 206 should not be restrictively associated with the illustration in FIG. 3. Those skilled in the art will recognize that the embodiments shown in FIG. 3 and FIG. 4 are interchangeable and one embodiment or a combination of embodiments can be utilized as display pipes in any particular application.

FIG. 5 is a flowchart of a procedure to use a display pipe in accordance with one embodiment of the present invention. The procedure begins as indicated at START 500 followed by operation 502 where a preceding pixel data, containing a pixel value and corresponding repeater value, is stored. In operation 504 an open register within a buffer is detected. The procedure continues with operation 506 where a new pixel value is retrieved from the memory. At operation 508 the retrieved pixel value is compared to the preceding pixel value. If the retrieved pixel value is the same as the preceding pixel value, operation 510 is executed where the repeater value for the preceding pixel value is incremented.

For example, if an image has two consecutive pixels with identical pixel values, the repeater value for the first of the consecutive identical pixels is incremented from zero to one after the second pixel value is compared to the first pixel value. Similarly, if there are three consecutive pixels of the same value, the repeater value for the first of the three consecutive pixels will be incremented to two. After finishing operation 510, the procedure returns to operation 504 and repeats as described above.

If the new pixel value is not the same as the preceding pixel value in operation 508, the procedure continues to operation 512 where the pixel data, containing the new pixel value and a corresponding repeater value, is recorded in the open register. Completion of operation 514 is followed by operation 516 where the new pixel data is designated as the preceding pixel data and then the procedure returns to operation 504 and repeats as described above.

FIG. 6 is a flowchart of a procedure to access pixel data from a display pipe in accordance with one embodiment of the present invention. The procedure begins as indicated at START 600. Moving to operation 602, a pixel data containing a pixel value with a corresponding repeater value is accessed from the FIFO registry. Operation 604 reads the repeater value followed by operation 606 where the procedure branches depending on the repeater value.

If the repeater value indicates that the pixel value is repeated, the procedure advances to operation 608 where the logic pauses the fetching of the next pixel data. Operation 610 uses this pause to output the retrieved pixel value as many times as indicated by the corresponding stored repeater value. The counter is used to decrement the repeater value each time the pixel value is output. Alternatively, the counter could increment a temporary value until the temporary value is equal to the number of consecutive pixels represented by the repeater value. Thus, if a pixel data has a repeater value of one, the pixel will be output a total of two times and the fetching of the next pixel data will be paused once. Similarly, if the pixel data has a repeater value of two, the pixel will be output a total of three times and the fetching of the next pixel data will be paused twice to accommodate the repeater value.

After operation 610 is performed, operation 614 designates the register storing the retrieved pixel data as empty, followed by operation 616 that resumes the fetching of a next pixel data. After completing operation 616 the procedure returns to operation 602 and repeats as described above. If the repeater value indicates that the pixel value is not repeated, the procedure performs operation 612 and the pixel value is output. Next, operation 614 is performed and the registers storing the retrieved pixel data are designated as empty. Operation 614 is followed by operation 616 where the next pixel data is fetched and then the procedure returns to operation 602.

One of the many advantages of using the claimed display FIFO is the ability to efficiently use FIFO memory. The use of a repeater value requires a minimal increase in the memory allocation for each registry location. However, the minimal increase in memory is offset by the increased efficiency of the FIFO. For example, four bits of additional memory would be needed to include a repeater value that can be incremented to 16. Because 24 bits are required to store the pixel value, a total of 28 bits would be required to store the pixel value and repeater value for up to 17 identical consecutive pixels. A FIFO buffer not using repeater values would require 408 bits (24 bits/pixel value A 17 pixel values) to store the data for the same 17 identical consecutive pixels. Thus, a display FIFO using repeater values saves 380 bits as compared to a display FIFO that does not use repeater values. Therefore, despite the minimal increase in memory allocation to record the repeater value, the improved efficiency of the claimed invention may allow less total memory to be allotted to FIFO buffers of the graphics controller 106 without degrading the ability of the graphics controller 106 to process images. Alternatively, using the claimed FIFO buffer may enable a graphics controller to handle more complex images than a regular display FIFO when each type of graphics controller has the same allocation of memory.

Although the foregoing invention has been described in some detail for purposes of clarity of understanding, it will be apparent that certain changes and modifications may be practiced within the scope of the appended claims.

We claim:

1. A graphics controller, comprising:
a display pipe;
a first-in-first-out (FIFO) buffer within the display pipe, the FIFO buffer storing pixel data representing an image for display, the pixel data including a pixel value and a corresponding repeater value, the repeater value indicating a number of times the pixel value is successively repeated within the image; and
selection logic for counting a number of times a pixel value is output, the selection logic further configured to pause fetching of a next pixel data from the FIFO buffer until the pixel value has been output as many times as indicated by the repeater value.

2. A graphics controller as in claim 1, wherein the repeater value is stored as a least significant bit of the pixel data.

3. A graphics controller as in claim 1, wherein the selection logic for counting the number of times the pixel value is output decrements the repeater value for each time the pixel value is output.

4. A graphics controller as in claim 1, wherein the selection logic for counting the number of times the pixel value is output increments a temporary value.

5. A graphics controller as in claim 1, further comprising:
a multiplexer configured to place the pixel value and the corresponding repeater value in the FIFO buffer; and a de-multiplexer configured to provide access to the pixel value and the corresponding repeater value.

6. A graphics controller as in claim 1, wherein the pixel value and the corresponding repeater value are stored in separate FIFO buffers.

7. A graphics controller as in claim 1, wherein the selection logic is configured to track a number of times the pixel value is consecutively repeated and save the number of times the pixel value is consecutively repeated as the repeater value corresponding to the pixel value.

8. A graphics controller as in claim 1, further comprising:
a counter configured to track the repeater value for writing into and reading from the FIFO buffer.

9. A graphics controller as in claim 1, where the graphics controller is integrated in a portable electronic device.

10. A method for writing to a FIFO buffer comprising:
recording to a register a preceding pixel data wherein the pixel data includes a preceding pixel value and a corresponding preceding repeater value;
retrieving a next pixel value from a memory;
comparing the next pixel value to the preceding pixel value using system logic;
if the next pixel value is equal to the preceding pixel value the method further includes incrementing the preceding repeater value;
if the new pixel value is different than the preceding pixel value the method further includes writing the next pixel value and a corresponding next repeater value to a register within the FIFO buffer and designating the next pixel as the preceding pixel.

11. The method according to claim 10, wherein the repeater value is stored as a least significant bit of the pixel data.

12. The method according to claim 10, wherein the pixel value and the corresponding repeater value is written to a register connected to a multiplexer and a de-multiplexer.

13. The method according to claim 10, wherein the pixel value is written to a buffer connected to a multiplexer and a de-multiplexer and the corresponding repeater value is stored in a register connected to a second multiplexer and a second de-multiplexer.

14. The method according to claim 10, wherein the method further includes outputting the pixel value as many times as indicated by the repeater value while pausing the fetching of the next pixel data.

15. A method for reading from a FIFO buffer comprising:
accessing the FIFO buffer storing the pixel data, wherein the pixel data includes a pixel value and a corresponding repeater value;
reading the repeater value corresponding with the pixel value using system logic;
outputting the pixel value as many times as indicated by the repeater value while pausing the fetching of a next pixel data; and
designating a region storing the pixel data as open.

16. The method according to claim 15, wherein the repeater value is stored as a least significant bit of the pixel data.

17. The method according to claim 15, wherein a counter decrements the repeater value when the pixel value is output and the fetching of the next pixel data resumes when the repeater value indicates the pixel value no longer is repeated.

18. The method according to claim 15, wherein a counter increments a temporary value when the pixel value is output and the fetching of the next pixel data resumes when the temporary value corresponds with a value indicating that the pixel data no long is repeated.

19. The method according to claim 15, wherein the pixel value and the corresponding repeater value is written to the FIFO buffer through a multiplexer.

20. The method according to claim 15, wherein the pixel value is written to the FIFO buffer connected to a first multiplexer and a first de-multiplexer and the corresponding repeater value is stored in another FIFO buffer connected to a second multiplexer and a second de-multiplexer.
